(19) United States
(12) Patent Application Publication
(10) Pub. No.: US 2021/0235278 A1
(43) Pub. Date: Jul. 29, 2021

(54) VIRTUALIZED RADIO ACCESS NETWORK

(71) Applicant: TELEFONAKTIEBOLAGET LM ERICSSON (PUBL), Stockholm (SE)

(72) Inventors: Chenguang LU, SOLLENTUNA (SE); Daniel CEDERHOLM, SOLLENTUNA (SE); Miguel BERG, SOLLENTUNA (SE); Simon DUQUENNOY, STOCKHOLM (SE); Niklas WIRSTRÖM, HÄSSELBY (SE)

(21) Appl. No.: 17/057,855

(22) PCT Filed: Aug. 30, 2018
(86) PCT No.: PCT/IB2018/056655

§ 371 Date: Nov. 23, 2020

Related U.S. Application Data
(60) Provisional application No. 62/677,957, filed on May 30, 2018.

(51) Int. Cl. H04W 16/18; H04L 29/08; H04L 12/46; H04L 25/02; H04W 88/08

(52) U.S. Cl. CPC H04W 16/18; H04L 67/10; H04W 88/16; H04L 25/02; H04W 88/085; H04L 12/4641

(57) ABSTRACT

Systems, methods and apparatuses are disclosed for virtualization of radio access network technology to provide baseband processing in a cloud environment. An example method includes providing a first virtualized network node that includes a feature function. The feature function is communicatively coupled to receive baseband data from a communication stack function of a second virtualized network node. The communication stack function of the second virtualized network node receives a plurality of baseband data and provides, via a cloud data distribution system, at least a subset of the plurality of baseband data to the feature function of the first virtualized network node.

### RELATED APPLICATIONS

The present application claims the benefit of priority from U.S. Provisional Application No. 62/677,957 entitled “MULTI-RAT IOT C-RAN DESIGN” filed May 30, 2018, the disclosure of which is hereby incorporated herein in its entirety by reference.

### TECHNICAL FIELD

The present disclosure relates to wireless communication systems and data processing, and more particularly to virtualization of radio access network technology.

### BACKGROUND

IoT has emerged as a hot topic in both industry and academia in recent years. Everything is expected to be connected in the Internet of Things (IoT) era, from critical infrastructures to consumer devices. According to Ericsson's mobility report, around 29 billion connected devices are forecast by 2022, of which around 18 billion will be related to IoT. IoT becomes one key enabler for digitalization, which will empower the society and people with the intelligence driven by the big amount of digital data collected.

It is expected that trillions of IoT devices will be connected in the next decade. Most of the devices serve so-called massive IoT applications, in which the large number of IoT devices are connected but each of them only generates small amount of traffic data. For example, power and/or water meters at home may only need to report several bytes a few times a day. For massive IoT applications, the IoT connectivity infrastructure needs to be extremely scalable to be able to support more and more devices connected to the network over time. The cost per connection (for example, the total cost of ownership) needs to be very low because such IoT subscriptions will be very low (no one would like to pay much for such low traffic). The current network design with dedicated HW-based base stations (or IoT gateways) may be too costly for such applications.

China Mobile Research Institute's white paper titled “The Road Towards Green RAN” describes that Cloud RAN can potentially increase network flexibility and reduce network total cost of ownership, due to site consolidation, using a cloud platform based on general purpose processors, and resource pooling. Further, Cloud RAN is described as benefiting network performance by increasing coordination possibilities. However, it is not deemed practical to implement Cloud RAN for cellular networks like Long-Term Evolution (LTE) and New Radio (NR) Access Technology, given the required high baseband complexity and telecom-grade reliability. This is because cloud infrastructures are designed primarily for Web services, which are best effort services. Cloud infrastructures are not designed to provide telecom-grade reliability. For that reason, C-RAN as applied to cellular networks in conventional technology generally refers more to Centralized-RAN than Cloud RAN. Centralized-RAN generally includes a cluster of physical baseband units (BBUs) interconnected with high-speed interconnect links, where the BBUs are not cloudified or virtualized.

### SUMMARY

The examples disclosed in the present disclosure provide techniques for data processing using virtualization of radio access network technology, resulting in improved efficiency and predictability of resource occupation, reductions in an amount of instantiated features and in resource occupation, and increased ease of development and integration for new features. Other advantages may be readily apparent to one having skill in the art. Certain embodiments may have none, some, or all of the recited advantages.

In an example, a method includes providing a first virtualized network node that includes a feature function. The feature function is communicatively coupled to receive baseband data from a communication stack function of a second virtualized network node. The communication stack function of the second virtualized network node receives a plurality of baseband data and provides, via a cloud data distribution system, at least a subset of the plurality of baseband data to the feature function of the first virtualized network node. Further, the present disclosure also provides example systems and apparatuses configured to perform the above methods, such as by providing a non-transitory computer-readable medium comprising computer instructions stored thereon that, when executed by a processing circuitry, cause the processing circuitry to perform the above methods. Systems and apparatuses are further described to include one or more communication interfaces, power supply circuitry, and/or other hardware, as well as one or more IoT, UE, or other devices that are communicatively coupled to said hardware.

### BRIEF DESCRIPTION OF THE DRAWINGS

For a more complete understanding of the disclosed embodiments and their features and advantages, reference is now made to the following description, taken in conjunction with the accompanying drawings.

FIG. 1 is a schematic block diagram illustrating a system including a cloud environment that provides feature functions and communication stack functions in the same virtualized network nodes, according to some examples.

FIG. 2 is a schematic block diagram illustrating a system including a cloud environment that provides feature functions and communication stack functions in separate virtualized network nodes, according to some examples.

FIG. 3 is a schematic block diagram illustrating a virtualized network node that provides communication stack functions, according to some examples.

FIG. 4 is a schematic block diagram illustrating an interconnection of application, service, and function entities in a multi-RAT network data center, according to some examples.

FIG. 5 is a flow diagram illustrating a method of baseband processing that is performed in a cloud environment, according to some examples.

FIG. 6 is a schematic block diagram illustrating a wireless network, according to some examples.

FIG. 7 is a schematic block diagram illustrating a user equipment, according to some examples.

FIG. 8 is a schematic block diagram illustrating a virtualization environment, according to some examples.

### DETAILED DESCRIPTION

There currently exist certain challenges in today's wireless system design. For example, today's wireless system design is mainly optimized to deliver high-performance mobile broadband services to serve human needs. It is difficult to assume that the same design paradigm of dedicated HW-based base stations (or IoT gateways) would achieve the required scalability and cost efficiency for massive IoT connectivity. Another challenge is that there are so many radio technologies and standards for IoT connectivity, such as Narrowband IoT (NB-IoT), Long Term Evolution category M1 (LTE-M), Bluetooth Low-Energy (BLE), ZigBee, Sigfox, LoRa, and IEEE 802.15.4, to name a few. They are designed to cover different IoT use cases by different standardization bodies and consortiums with different requirements on performance and cost level. Many IoT scenarios, such as smart factory and smart building, support several use cases at the same time. A single technology may not be able to provide such support for all of these use cases. Therefore, parallel networks with dedicated base stations per coverage are deployed in such scenarios. This parallel network deployment can drive up the network costs significantly.

Certain aspects of the present disclosure and their embodiments may provide solutions to these or other challenges. For example, techniques are described herein to decouple communication stack functions and feature functions into separate virtualized network nodes (VNNs) in an IoT Cloud RAN design. Moreover, these techniques may include distributing In-phase and Quadrature (IQ) samples from communication stack VNNs to feature VNNs via a cloud data distributions system.

The techniques described herein may be used to apply Cloud RAN concepts to massive IoT. Cloud RAN is a concept for cloudifying cellular networks, such as LTE and NR, where the remote radio units (RRU) have fiber connections to data centers and the baseband units (BBUs) are virtualized as virtual machines (VMs) or containers in data centers (i.e. a cloud environment) for baseband and higher layer processing. A fronthaul (FH) interface is used to transport IQ samples between RRUs and the virtualized BBUs. The protocols for IQ sample transport can be over CPRI or eCPRI, both of which are standardized FH protocols specified in the Common Public Radio Interface (CPRI) cooperation (see http://www.cpri.info).

Unlike more critical services that are supported by LTE and NR, such as mobile broadband and ultra-reliable and low-latency communication (URLLC), massive IoT services have more relaxed requirements in terms of throughput and latency. Further, the massive IoT technologies are usually characterized by narrow band and low complexity due to the low-cost requirement of the terminals. These characteristics, i.e. low throughput, high latency, low complexity as well as relaxed reliability, make it possible to implement Cloud RAN for IoT technologies. Another benefit for IoT Cloud RAN is that it can support multiple radio access technology (multi-RAT) networks with one radio infrastructure. The baseband support for different RATs are done by software (i.e. virtualized BBUs) in the cloud. This dramatically reduces the network costs.

To implement Cloud RAN for IoT, an IoT base station (or gateway, access point(s), etc.) is split into two parts: an IoT radio head (RH) and an IoT BBU, following the same architecture of RRU and BBU in cellular networks. The IoT RHs provides the radio coverage of a certain area (which may be similar to the cells or sectors defined in cellular networks) and handles the radio-related processing, and performs conversions between baseband signals and RF signals. One IoT RH supports at least one carrier. The IoT BBUs are virtualized in a cloud (for example, in one or more data centers) and handle baseband processing and/or higher layer processing. Each IoT BBU supports at least one cell with one carrier of one RAT.

An FH interface transports IQ samples between IoT RH and virtualized BBUs. Each virtualized IoT BBU may be virtualized as one VNN, which may be included in a VM and/or a container. The VNN handles certain network functions in a cloud environment, which may be provided at a data center. In some examples, a cloud environment is located at Central Offices (COs) of telecom operators, server rooms in commercial buildings and factory plants, and so forth. In some environments, the cloud environment is provided at a micro data center at a network edge (e.g., an edge cloud implementation).

In other examples, functions are virtualized separately on protocol stack level. For example, each communication protocol layer, e.g. PHY (L1), MAC (L2), IP (L3) etc., can be virtualized as one VNN (which may be provided by a VM and/or container). An IoT BBU may then be virtualized by chaining these VNNs together. Accordingly, in this example, the functional split for virtualization is done vertically on the protocol stack. Examples of baseband functions that may be virtualized include PHY (L1) related functions, which are particularly relevant for cloud RAN because baseband functions are normally executed in an ASIC or DSPs originally in HW-based base stations (or gateway, access points, and so forth).

Baseband functions may be categorized into two types of functions: communication stack functions and auxiliary functions. Communication stack functions are baseband functions that implement the transceiver chain for communication tasks, such as by implementing the specifications of the communication standards such as NB-IoT, LTE-M, BLE, ZigBee, Sigfox, LoRa, IEEE 802.15.4, and so forth. These communication stack functions cause the communication to work, by performing activities such as modulation/demodulation, coding/decoding, multiple-input and multiple-output (MIMO)/beamforming operations, channel estimation, equalization, and so forth.

Auxiliary baseband functions are baseband functions other than the communication stack functions. Auxiliary baseband functions access baseband data and run in parallel to the communication stack functions to improve communications, and are not required for communication transmission. Examples of auxiliary baseband functions include (1) feature functions, such as localization estimation functions and interference analysis functions, and (2) non-feature functions, such as some management-related functions that generally have lower processing requirements than feature functions.

As described above, localization estimation and interference analysis functions are examples of auxiliary functions that are feature functions. Localization estimation functions usually rely upon sophisticated processing on received IQ samples. Such sophisticated processing may include employing phase-shift analysis on different channels, for Angle-of-Arrival (AoA) estimation (e.g. MUSIC algorithm), or methods such as Synthetic Aperture Radar (SAR). Interference analysis functions can be highly compute-intensive, such as when they are based on machine learning methods (e.g. deep learning) for interference classification (identifying burstiness and other channel features). An example characteristic of a feature function may be that it often behaves highly dynamically and consumes a lot of resources when active.

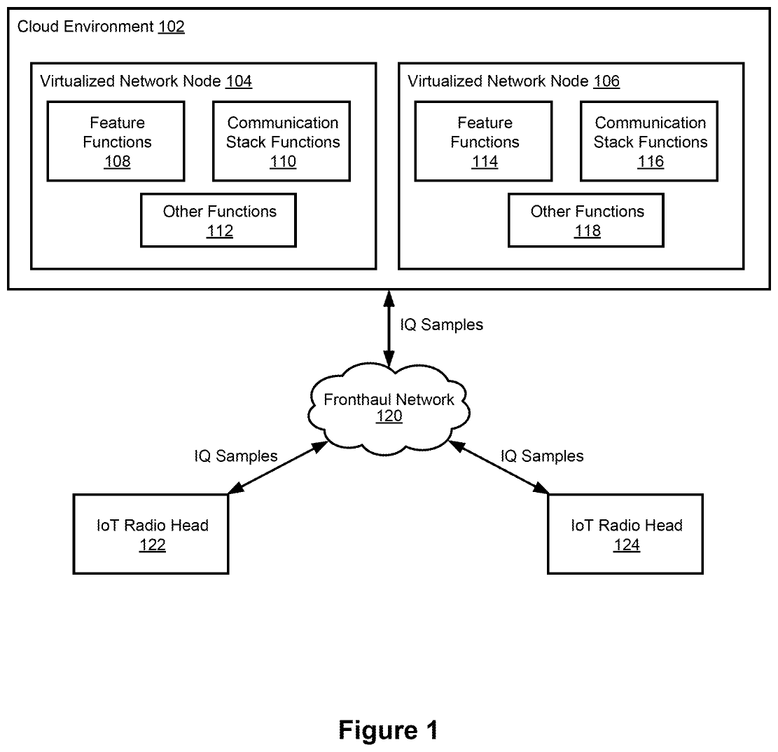

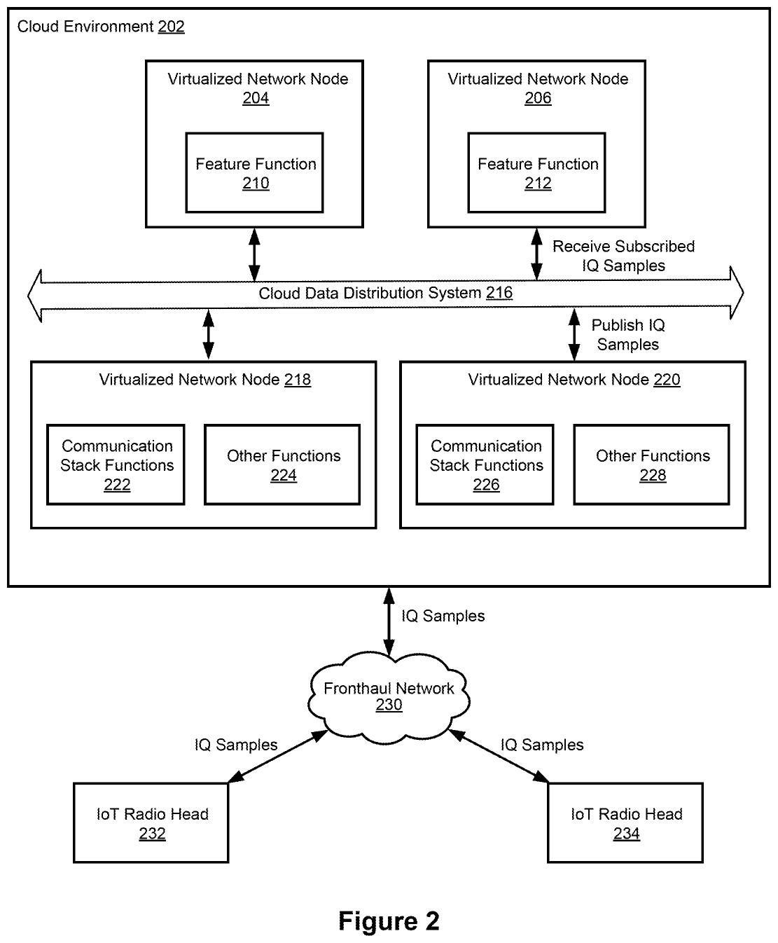

In some examples, such as those described with respect to FIG. 1, all baseband functions are virtualized together in one VNN, such as one VM or container, providing a full virtualization of an IoT PHY implementation including communication stack functions, feature functions, and other auxiliary baseband functions. In other examples, however, such as those described with respect to FIG. 2, feature functions are decoupled from communication stack functions and other auxiliary baseband functions using separate virtualized network nodes that communicate via a cloud data distribution system.

Certain embodiments may provide one or more of the following technical advantage(s). Generally, the techniques described herein improve the efficiency of the IoT cloud RAN implementation and can also support multi-RAT network implementation. In addition, gathering IQ samples from different RATs increases the richness of the data. Separating the feature functions provides the communication stack VNN with more predictable resource occupation. This helps avoid overprovisioning of computing and storage resources for VNNs and improves the resource pooling to serve more communication stack VNNs given fixed amount of resources available. Virtualizing the feature functions separately allows them to be dimensioned separately in terms of required computing, storage and networking resources. One such feature VNN can be shared by multiple communication stack VNNs, as the need for the feature VNN can be dynamic. This helps reduce the number of instantiated feature VNNs and reduces the overall resource occupation.

Moreover, the techniques described herein accelerate innovation. Distributing IQ samples in the system to feature VNNs via specific APIs allows new feature VNNs to be developed and integrated easily. The techniques described herein also enable the feature VNNs to utilize advanced cloud capabilities, e.g. advanced data analytics, machine learning, Big Data (data storage) etc. provided by the cloud service provider.

FIG. 1 is a schematic block diagram illustrating a system including a cloud environment that provides feature functions and communication stack functions in the same virtualized network nodes, according to some examples.

In the present example, the cloud environment 102 provides virtualized network node 104 and virtualized network node 106. In other examples, there may be additional or fewer virtualized network nodes. The virtualized network nodes 104 and 106 are each integrated with all functions of a virtualized BBU, acting the same way as a physical BBU (at least the PHY part of the BBU). Thus, virtualized network node 104 includes feature functions 108, communication stack functions 110, and other functions 112. Similarly, virtualized network node 106 includes feature functions 114, communication stack functions 116, and other functions 118.

Each virtualized network node 104 and 106 is virtualized by running in a virtual machine (VM) or container (OS-level virtualization). In some examples, container technologies are preferred because of their low overhead, when applicable, for example whenever the VNN does not require any particular OS or kernel version. Examples of such container technologies include Docker, LXD, and so forth. VMs may be preferred in other examples because they offer a higher degree of flexibility. That is, in a VM, a VNN includes its own OS and kernel, such that the VNN can provide access to peculiar low-level features. Examples of VM technologies include VMWare and VirtualBox.

Each communication stack function 110 and 116 provides a baseband implementation of a same or different standard. As described above, examples of an IoT RAT standard that may be supported include NB-IoT, LTE-M, BLE, ZigBee, Sigfox, LoRa, and IEEE 802.15.4. For example, virtualized network node 104 can provide a NB-IoT base station by processing data using communication stack functions 110 and virtualized network node 106 can be a long-range low-power wireless platform (such as a LoRa) base station by processing data using communications stack function 116.

Each virtualized network node 104 and 106 can support a different cell or sector. For example, virtualized network node 104 can be an NB-IoT base station of cell 1 (or sector 1), while virtualized network node 106 can be an NB-IoT base station of cell 2 (or sector 2). Accordingly, the communication stack functions 110 and 116 receive IQ samples from the fronthaul network 120, and process the IQ samples to provide the data to other functions (e.g., feature function 108 or 114, or other function 112 or 118) within their virtualized network nodes. That is, communication stack functions 110 pass IQ samples to feature functions 108 and other functions 112, while communication stack functions 116 pass IQ samples to feature functions 114 and other functions 118.

In the present example, IQ samples of cell 1 (corresponding to IoT radio head 122, in this example) are received via fronthaul network 120 and directed from/to and processed in virtualized network node 104. Similarly, IQ samples of cell 2 (corresponding to IoT radio head 124) are received from fronthaul network 120 and processed in virtualized network node 106. Here, cell 1 and cell 2 can be on the same carrier frequency or on different carrier frequencies (on the same band or on different bands). In yet another configuration, a virtualized network node can be shared between more than one cells (or sectors) when traffic load is low on these cells, to increase cloud resource utilization.

FIG. 2 is a schematic block diagram illustrating a system that includes a cloud environment that provides feature functions and communication stack functions in separate virtualized network nodes, according to some examples.

In the present example, the cloud environment 202 provides virtualized network nodes 204, 206, 218, and 220, which is virtualized by running in either a VM or container (OS-level virtualization). As in FIG. 1, container technologies may be preferred because of their low overhead, when the VNN does not require any particular OS or kernel version, while VMs may be preferred in other examples because they offer a higher degree of flexibility.

Unlike in FIG. 1, for each RAT the feature functions 210 and 212 are virtualized in separate virtualized network nodes 204 and 206, respectively, while the communication stack functions 222 and 226 and other supporting functions 224 and 228 are virtualized in separate virtualized network nodes 218 and 220. Accordingly, in this example, virtualized network node 204 that includes feature function 210 is decoupled from virtualized network node 218 that includes communication stack functions 222 and other functions 224. Similarly, feature virtualized network node 206 that includes feature function 212 is decoupled from virtualized network node 220 that includes communication stack functions 226 and other functions 228.

Each communication stack 222 and 226 of virtualized network nodes 218 and 220, respectively, provides the needed baseband data (e.g., IQ samples) to feature functions 210 and/or 212 of virtualized network nodes 204 and/or 206 through a cloud data distribution system 216 that provides messaging protocols and cloud data storage. The cloud data distribution system can be based on publish-subscribe, push-pull, request-reply, and/or other communication techniques to communicatively couple elements of the system (such as feature functions 210 and/or 212 to communication stack functions 222 and/or 226). Examples of cloud data distribution systems include, but are not limited to RabbitMQ, Kafka, DDS, and so forth. In this disclosure, IQ samples are emphasized for baseband data, but other types of data may be communicated as well.

In this example, the cloud data distribution system 216 acts like a data bus with access to a data repository. The cloud data distribution system 216 may include a Message Queue system and/or a Distributed Streaming platform, and be broker-based or completely distributed. In broker-based platforms like Kafka and RabbitMQ, data message handling and storage is done by brokers (or broker servers). The data publishers and subscribers communicate via the proxy servers through APIs provided by the data distribution system. In completely distributed platform like DDS, each participating party (publishers and subscribers) contributes its own resources for data message handling and storage by implementing a software plugin following the specification of the data distribution system.

In some examples, data can be organized as topics. Using a publish-subscribe approach, the feature functions (210 and/or 212) subscribe to and receive their interested topics of IQ samples (including the related meta data, e.g. time stamps, cell id, UE id, MAC address, etc.) from communication stack functions 222 and/or 226. The communication stack functions 222 and/or 226 publish the corresponding IQ samples of these topics to the subscribed feature functions. Publishing and subscribing relating to IQ samples may be implemented using APIs and/or implementing software plugins provided by cloud data distributions system 216. In some examples, the cloud data distributions system 216 supports request/reply mechanism for data distribution. In this approach, feature functions of the virtualized network nodes request the IQ samples from the communication stacks functions of other virtualized network nodes, and the communication stack functions reply with the requested IQ samples. While the above examples are provided in the context of publish-subscribe protocols, other approaches may be implemented (such as push-pull), to communicatively couple the feature and communication stack functions in the system.

Examples of feature functions that may be implemented in a virtualized network node include localization estimation functions and interference analysis functions. A localization estimation function estimates the location of IoT devices (in the IoT context) and/or UE (in the cellular context). Accordingly, in some examples, a localization estimation feature function of a virtualized network node gathers the IQ samples from the communication stack functions of virtualized network nodes corresponding to different IoT RHs around the IoT device of interest and uses the IQ samples to estimate the location of an IoT or other user device. This improves the localization accuracy by joint processing of the raw IQ samples together with more processing resources allocated in the cloud and utilizing the advanced cloud capability of Big Data and advanced machine learning.

Another example of a feature function that may be implemented in a virtualized network node includes an interference analysis function. Communication channels can get congested when too much traffic is loaded on the same carrier, on the same band or on the same RAT. Interference analysis helps understand the interference situation and provide such information to other network control functions or virtualized network nodes. For example, a load balancing function can use the interference analysis to load the traffic better among available carriers and RATs and relieve congestion. The network configuration can be also optimized if the interference situation can be predicted. These both can improve the spectrum efficiency. Therefore, understanding the interference situation is the key. Here, the interference analysis can be done in a more centralized way and can jointly process the raw IQ samples from adjacent cells that interfere each other. In addition, more processing and storage resources in cloud can be allocated, and advanced cloud capability (e.g. advanced machine learning) can be utilized. All these will help get more accurate estimate of the interference situation of a network.

The virtualized network nodes and other elements described with respect to FIG. 2 may be configured to provide at least some functionality similar to FIG. 1. For example, the virtualized network node 204 and communication stack virtualized network node 218 can be the baseband implementation of the same standard or different standards as the virtualized network node 206 and virtualized network node 212. For example, the virtualized network nodes 204 and 218 can provide an NB-IoT base station of cell 1 (or sector 1), while virtualized network nodes 206 and 220 can provide an NB-IoT base station of cell 2 (or sector 2). In other examples, each of the virtualized network nodes 218 and 220 provides a communication stack function 222 or 226 that supports different communication standards (e.g., one or more of NB-IoT, LTE-M, BLE, ZigBee, Sigfox, LoRa, or IEEE 802.15.4, and so forth).

Accordingly, in this example, IQ samples of a particular cell (corresponding to IoT radio head 232, in this example) are received via fronthaul network 230 and directed from/to and processed in virtualized network node 218, which may publish IQ samples to virtualized network node 204 that has subscribed to receive the IQ samples. Similarly, IQ samples of another cell (corresponding to IoT radio head 234) are received from fronthaul network 220 and directed from/to and processed in communication stack virtualized network node 220, which may publish IQ samples to virtualized network node 206 that has subscribed to receive the IQ samples. Here, each cell can be on the same carrier frequency or on different carrier frequencies (on the same band or on different bands).

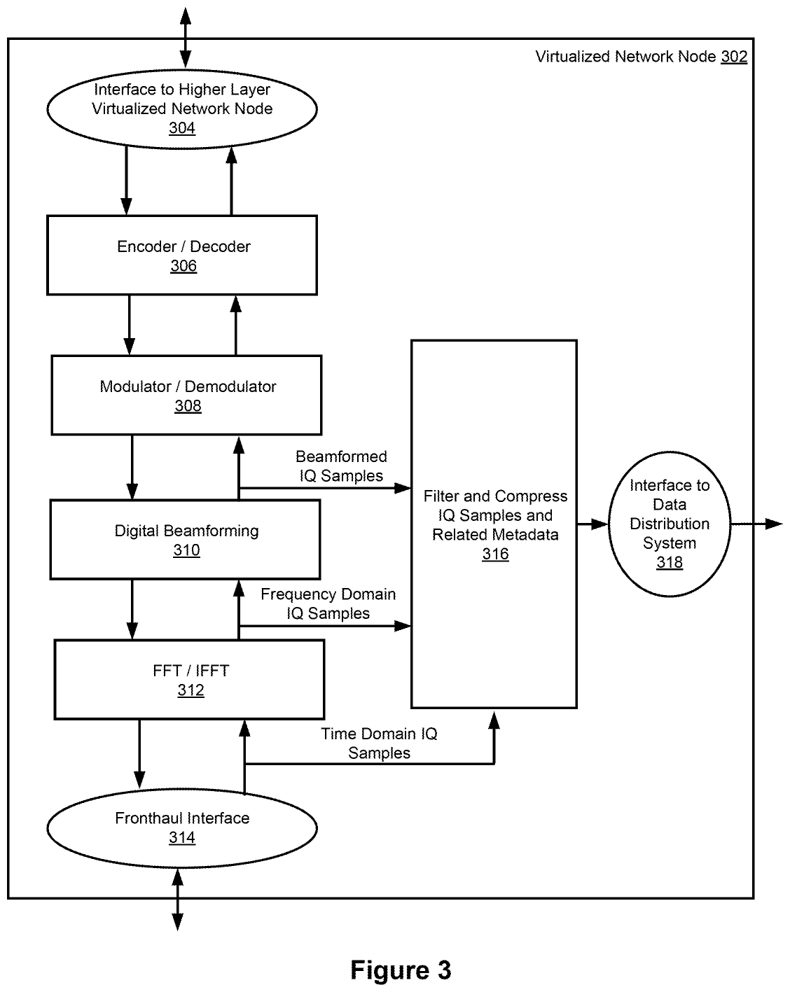

FIG. 3 is a schematic block diagram illustrating a virtualized network node that provides communication stack functions, according to some examples. In some examples, this virtualized network node is used to implement one or more of virtualized network node 218 or 220, which are described with respect to FIG. 2. These functions may also be implemented in the communication stack functions 110 and/or 116 that are described with respect to FIG. 1.

The present example includes a virtualized OFDM-based communication system, such as NB-IoT, WiFi, and so forth. In this example, IQ samples can be obtained on different levels. Here, three options are shown: (1) time-domain IQ samples, (2) frequency-domain IQ samples, and (3) beamformed IQ samples (IQ samples after MIMO and beamforming processing).

In the present example, the virtualized network node 302 provides interfaces including an interface to a higher layer virtualized network node 304, a fronthaul interface 314, and an interface to a data distribution system 318. These interfaces may be accessed by external modules to access functions including an encoder and/or decoder 306, modulator and/or demodulator 308, digital beamforming module 310, fast Fourier transform (FFT) and/or inverse fast Fourier transform (IFFT) module 312, and/or compressor module 316 for IQ samples and related metadata.

For different applications and communication standards, different types of IQ samples can be used. For example, for IoT or UE localization estimation, if the standard uses frequency-domain scheduling (e.g. in NB-IoT), frequency domain IQ samples are better to be used. If the standard only does time-domain scheduling (e.g., in WiFi), time domain IQ samples may be used. For interference analysis, time-domain IQ samples can provide the insights about out-of-carrier interference situation, while frequency domain and beamformed IQ samples can be used to obtain the insights of the interference issues on the same carrier.

In some examples, the IQ samples are extracted or filtered, since only specific segments of these IQ samples are needed by the feature functions of virtualized network nodes. In some examples, IQ samples are compressed (e.g., using module 316) to reduce the bandwidth of IQ sample data. The compression can be lossless compression like Huffman coding and/or lossy compression. Then IQ samples (including the related metadata, e.g. time stamps, cell id, UE id, MAC address etc.) are sent to the cloud data distribution system (such as via module 318) for the feature functions of virtualized network nodes to consume.

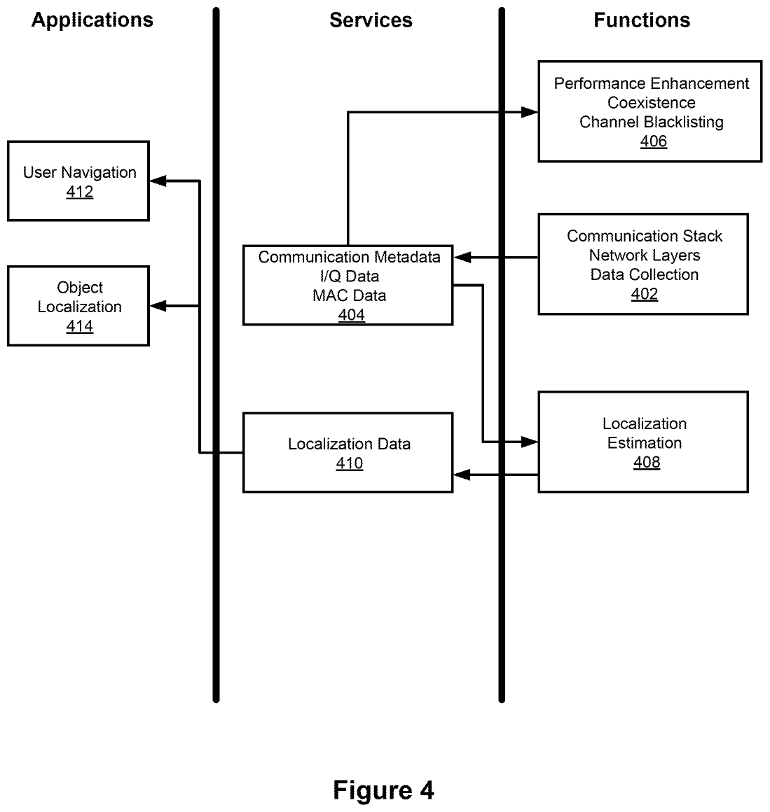

FIG. 4 is a schematic block diagram illustrating an interconnection of application, service, and function entities in a multi-RAT network data center, according to some examples. In some examples, aspects of the interconnection of entities described with respect to FIG. 4 is implemented via virtualization in the cloud environments that are described with respect to FIG. 1 and/or FIG. 2.

In the present example, the data center includes multiple technology-agnostic access points to future-proof the IoT connectivity. One or more of the access point acts as a radio front-end, but signal modulation/demodulation as well as the rest of the communication stack in the data center is decoupled from the feature portion, for example as described with respect to FIG. 2.

Access points collect low-level physical-layer information (IQ samples as well as metadata) and makes it available through a function that provides a communication stack 402. The communication stack 402 implements IoT communication layers (L1, L2 etc.) and related functions (e.g. management and control functions). Each function acts as a virtualised modem for one IoT technology. Example IoT technologies under consideration include those described above, such as IEEE 802.15.4 (both non-beacon-enabled and TSCH), NB-IoT, BLE, LoRa, and so forth. The communication stack function 402 gathers low-level radio signals (such as IQ samples) at the edge.

The information from the communication stack 402 is provided via a communication metadata service 404 to functions for performance enhancement 406 (which may include functions for channel blacklisting and scheduling, interference mitigation, and/or other performance enhancement functions) and localization estimation 408. One or more functions for performance enhancement 406 are included for IoT communication technologies, e.g.: IEEE 802.15.4 at both 2.4 Ghz and subGHz, BLE, NB-IoT. These functions rely on low-level signal information (IQ signals and metadata, available through the services) to learn about the radio environment and then configure devices for improved co-existence, throughput, latency, reliability etc.

The information from the communication stack 402 is also provided via the communication metadata service 404 to a function for location estimation 408. This function exploits low-level IQ samples, as well as communication stack metadata. In some examples, the localization estimation 408 leverages phase difference between multiple antennas at each anchor, and uses DTOA (differential time of arrival) between different anchors to infer location. The localization estimation function 408 publishes its location estimates through the service for localization data 410 to applications that subscribe to the service's location estimates.

The service for localization data 410 provides localization data estimated from IQ signals by localization estimation function 408 to applications. The location data may be in the form of coordinates or area identifier, for applications such as user navigation 412 or object localization 414. The application for user navigation 412 is deployed to provide users with navigation, with the input being the location data supplied by the localization data 410 service. Applications for object location 414 may be deployed in IoT devices (e.g., in a shopping mall, such IoT device locations could include trash cans or advertisement boards in the shopping mall). These devices may be localized automatically. For instance, in the shopping mall example, trash cans can report when they are full, and boards can be used for targeted ads.

The architecture described above enables support for multiple RATs, thus enabling serving multi-RATs in one edge infrastructure, providing services (e.g., communication metadata 404 including IQ sample data and other metadata and/or and localization data 410 services), and enabling advanced applications (e.g., user navigation 412 and object localization 414). In the present example, the communication stack 402, localization estimation 408, and performance enhancement 406 are implemented as different VNNs in a cloud environment. For example, as shown in FIG. 2, communication stack functions 222 are implemented in a virtualized network node 218 that also includes other functions 224. Similarly, the localization estimation 408 and performance enhancement 406 may also be implemented in a virtualized network node that includes feature functions. For example, as shown in FIG. 2, virtualized network node 204 includes feature function 210, which may include localization estimation 408 and/or performance enhancement 406 functions.

The services for communication metadata 404 (e.g. IQ sample data) and localization data 410 include data published through a cloud data distribution system. For example, in FIG. 2, such data may be published via cloud data distribution system 216 as a service. In the present example, the localization estimation 408 and performance enhancement 406 feature functions subscribe to the service of communication metadata 404 to get IQ samples to perform localization processing and interference analysis, respectively. In this example, localization estimation 408 further publishes its location estimates as the service of localization data 410 to the applications (e.g., user navigation 412 and/or object localization 414) that subscribe to this service.

While the above techniques are described in the context of the publish-subscribe messaging protocol, it is understood that other messaging protocols (such as push-pull, and/or others) may be used to communicatively couple the functions for sharing data.

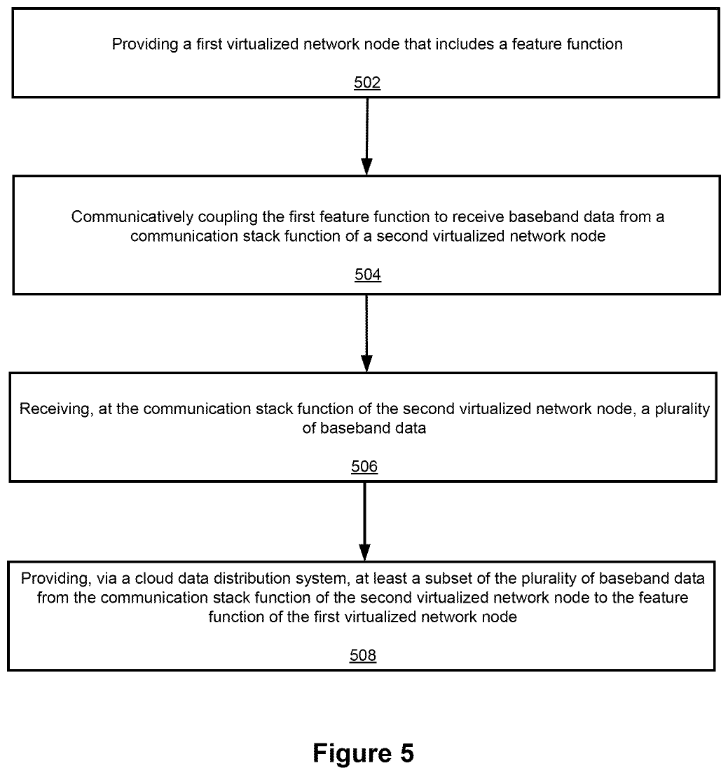

FIG. 5 is a flow diagram illustrating a method of baseband processing that is performed in a cloud environment, according to some examples. In some examples, the method is performed in the cloud environment that is described with respect to FIG. 2, using the communication stack elements described with respect to FIG. 3, and using an interconnection of applications, services, and functions as described with respect to FIG. 4.

At step 502, a first virtualized network node is provided that includes a feature function. In the present example, the feature function performs at least one of localization estimation or interference analysis.

At step 504, the feature function is communicatively coupled to receive baseband data from a communication stack function of a second virtualized network node. In some examples, the communicative coupled is provided by the feature function subscribing to receive baseband data from the communication stack function of the second virtualized network node. For example, the feature function may subscribe to receive data relating to a particular topic (e.g., a topic-based system) or having a particular attribute (e.g., a content based system). In other examples, the communicative coupling may be performed by establishing a push-pull messaging protocol to communicate data between the feature function and the communication stack function.

In the present example, wherein the communication stack function performs one or more of modulation, demodulation, coding, decoding, multiple-input and multiple-output (MIMO), beamforming operations, channel estimation, or equalization. In some examples, the communication stack function implements an Internet of Things (IoT) radio technology standard that is at least one of: Narrowband IoT (NB-IoT), Long Term Evolution category M1 (LTE-M), Bluetooth Low-Energy (BLE), ZigBee, Sigfox, LoRa, or IEEE 802.15.4.

At step 506, the communication stack function of the second virtualized network node receives a plurality of baseband data. In the present example, the plurality of baseband data includes In-phase and Quadrature (IQ) samples that are received from a fronthaul network.

At step 508, the communication stack function of the second virtualized network node provides, via a cloud data distribution system, at least a subset of the plurality of baseband data to the feature function of the first virtualized network node. The at least a subset of the plurality of baseband data may include all or a portion of the baseband data, depending on the particular subscription. As described above, the communication stack function may be communicatively coupled to the feature function by the feature function subscribing to receive particular data from the communication stack function. Accordingly, the communication stack function may provide the particular data by publishing the particular data to the feature function. In other examples, such as in a push-pull messaging architecture, (1) the communication stack function may push the particular data via the cloud data distribution system and/or (2) the feature function may pull the particular data from the communication stack function via cloud data distribution system.

In other examples, the method further includes providing additional, different network nodes, such as a third virtualized network node that includes a second feature function and a fourth virtualized network node that includes a second communication stack function. In these other examples, the feature function and the second feature function each may perform a different one of localization estimation and interference analysis. Similarly, the communication stack function and the second communication stack function may each implement a same or a different IoT radio technology standard.

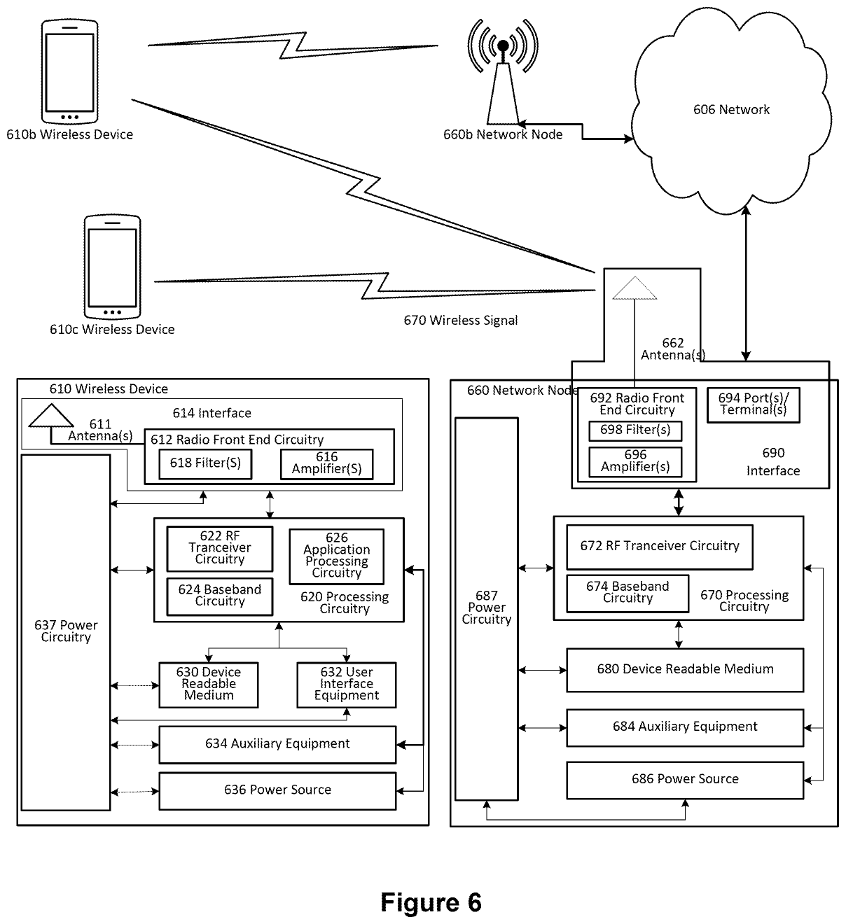

FIG. 6 is a schematic block diagram illustrating a wireless network, according to some examples. Although the subject matter described herein may be implemented in any appropriate type of system using any suitable components, the embodiments disclosed herein are described in relation to a wireless network. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions, and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

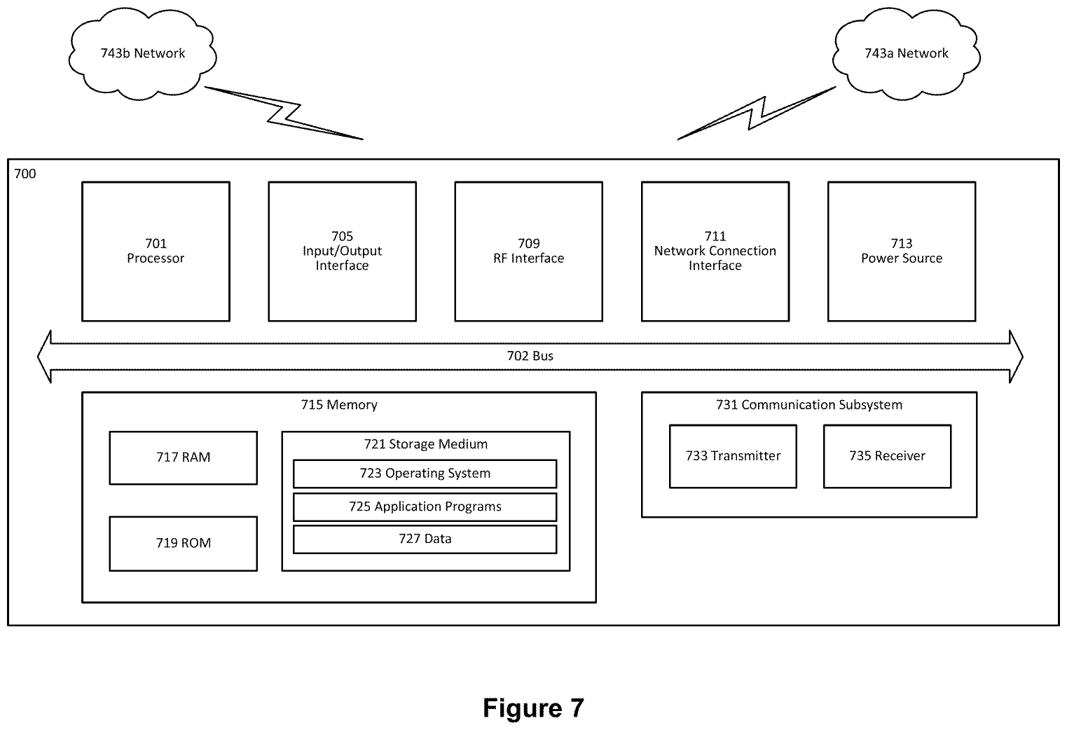

FIG. 7 is a schematic block diagram illustrating a user equipment, according to some examples. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device, such as an IoT device, that is not intended for sale to, or operation by, an end user but which may be associated with or operated for the benefit of a user (e.g., a smart power meter). UE 700 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

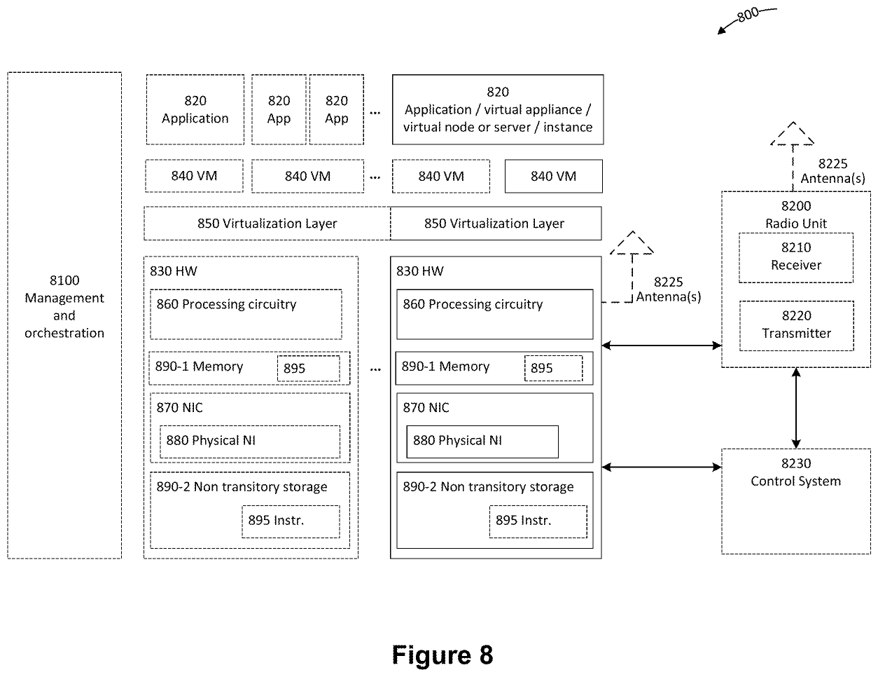

FIG. 8 is a schematic block diagram illustrating a virtualization environment, according to some examples. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

Modifications, additions, or omissions may be made to the methods, systems, and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. The methods may include more, fewer, or other steps. Additionally, steps may be performed in any suitable order. Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

1. A method performed in a cloud environment that performs baseband processing, the method comprising:
providing a first virtualized network node that includes a feature function;
communicatively coupling the feature function to receive baseband data from a communication stack function of a second virtualized network node;
receiving, at the communication stack function of the second virtualized network node, a plurality of baseband data; and
providing, via a cloud data distribution system, at least a subset of the plurality of baseband data from the communication stack function of the second virtualized network node to the feature function of the first virtualized network node.

2. The method of claim 1, wherein the feature function performs at least one of localization estimation or interference analysis.

3. The method of claim 1, wherein the communication stack function performs one or more of modulation, demodulation, coding, decoding, multiple-input and multiple-output (MIMO), beamforming operations, channel estimation, or equalization.

4. The method of claim 1, wherein the communication stack function implements an Internet of Things (IoT) radio technology standard that is at least one of: Narrowband IoT (NB-IoT), Long Term Evolution category M1 (LTE-M), Bluetooth Low-Energy (BLE), ZigBee, Sigfox, LoRa, or IEEE 802.15.4.

5. The method of claim 1, wherein the plurality of baseband data includes In-phase and Quadrature (IQ) samples that are received from a fronthaul network.

6. The method of claim 1, further comprising:
providing a third virtualized network node that includes a second feature function, wherein the second feature function is different than the feature function; and
providing a fourth virtualized network node that includes a second communication stack function, and wherein the second communication stack function is different than the communication stack function.

7. The method of claim 6, wherein the feature function and the second feature function each perform a different one of localization estimation and interference analysis.

8. The method of claim 6, wherein the communication stack function and the second communication stack function each implement a different IoT radio technology standard.

9. The method of claim 6, wherein the communication stack function and the second communication stack function each implement a same IoT radio technology standard.

10. A non-transitory computer readable medium having stored thereon software instructions that, when executed by a processor, cause the processor to perform operations comprising:
providing a first virtualized network node that includes a feature function;
communicatively coupling the feature function to receive baseband data from a communication stack function of a second virtualized network node;
receiving, at the communication stack function of the second virtualized network node, a plurality of baseband data; and
providing, via a cloud data distribution system, at least a subset of the plurality of baseband data from the communication stack function of the second virtualized network node to the feature function of the first virtualized network node.

11. The non-transitory computer readable medium of claim 10, wherein the feature function performs at least one of localization estimation or interference analysis.

12. The non-transitory computer readable medium of claim 10, wherein the communication stack function performs one or more of modulation, demodulation, coding, decoding, multiple-input and multiple-output (MIMO), beamforming operations, channel estimation, or equalization.

13. The non-transitory computer readable medium of claim 10, wherein the communication stack function implements an Internet of Things (IoT) radio technology standard that is at least one of: Narrowband IoT (NB-IoT), Long Term Evolution category M1 (LTE-M), Bluetooth Low-Energy (BLE), ZigBee, Sigfox, LoRa, or IEEE 802.15.4.

14. The non-transitory computer readable medium of claim 10, wherein the plurality of baseband data includes In-phase and Quadrature (IQ) samples that are received from a fronthaul network.

15. The non-transitory computer readable medium of claim 10, further comprising:
providing a third virtualized network node that includes a second feature function, wherein the second feature function is different than the feature function; and
providing a fourth virtualized network node that includes a second communication stack function, and wherein the second communication stack function is different than the communication stack function.

16. The non-transitory computer readable medium of claim 15, wherein the feature function and the second feature function each perform a different one of localization estimation and interference analysis.

17. The non-transitory computer readable medium of claim 15, wherein the communication stack function and the second communication stack function each implement a different IoT radio technology standard.

18. The non-transitory computer readable medium of claim 15, wherein the communication stack function and the second communication stack function each implement a same IoT radio technology standard.

19. A system for processing Internet of Things data in a Cloud Radio Access Network comprising:
processing circuitry configured to perform operations including:
providing that includes a feature function;
communicatively coupling to receive baseband data from a communication stack function of a second virtualized network node;
receiving, at the communication stack function of the second virtualized network node, a plurality of baseband data; and
providing, via a cloud data distribution system, at least a subset of the plurality of baseband data from the communication stack function of the second virtualized network node to the feature function.

20. The system of claim 19, wherein the feature function performs at least one of localization estimation or interference analysis.

21. The system of claim 19, wherein the communication stack function performs one or more of modulation, demodulation, coding, decoding, multiple-input and multiple-output (MIMO), beamforming operations, channel estimation, or equalization.

22. The system of claim 19, wherein the communication stack function implements an Internet of Things (IoT) radio technology standard that is at least one of: Narrowband IoT (NB-IoT), Long Term Evolution category M1 (LTE-M), Bluetooth Low-Energy (BLE), ZigBee, Sigfox, LoRa, or IEEE 802.15.4.

23. The system of claim 19, wherein the plurality of baseband data includes In-phase and Quadrature (IQ) samples that are received from a fronthaul network.

24. The system of claim 19, further comprising:
providing a third virtualized network node that includes a second feature function, wherein the second feature function is different than the feature function; and
providing a fourth virtualized network node that includes a second communication stack function, and wherein the second communication stack function is different than the communication stack function.

25. The system of claim 24, wherein the feature function and the second feature function each perform a different one of localization estimation and interference analysis.

26. The system of claim 24, wherein the communication stack function and the second communication stack function each implement a different IoT radio technology standard.

27. The system of claim 24, wherein the communication stack function and the second communication stack function each implement a same IoT radio technology standard.

28. The system of claim 19, further comprising:
at least one of an IoT or a UE that is communicatively coupled to the communication stack function of the second virtualized network node.
